(19) United States
(12) Patent Application Publication
(10) Pub. No.: US 2012/0233063 A1
(43) Pub. Date: Sep. 13, 2012

(54) Method of Real Estate Sale

(76) Inventor: Forrest Bailey, Newport News, VA (US)

(21) Appl. No.: 13/414,665

(22) Filed: Mar. 7, 2012

Related U.S. Application Data
(60) Provisional application No. 61/450,102, filed on Mar. 7, 2011.

(51) Int. Cl. G06Q 50/16; G06Q 40/00

(52) U.S. Cl. 705/39; 705/316

(57) ABSTRACT

A method of real estate sale is presented that makes the parties of a typical real estate transaction into employees. The seller, the buyer, and the two realtors typically involved in a real estate transaction are all employees of a company. The relationships between the seller, the buyer, and the two realtors is maintained by a computer or similar device such that upon sale of real estate between the seller and the buyer, the buyer does not just pay the seller, and in the seller owes appropriate real estate commissions to the realtors; but rather, the realtors receive funds—but so do the seller and the buyer.

### CONTINUITY DATA

This is a non-provisional application of provisional application No. 61/450,102 filed on Mar. 7, 2011 and priority is claimed thereto.

### FIELD OF THE INVENTION

The present invention is a method for selling real estate using a computer or similar hardware device. More specifically, the present invention creates a unique relationship between the buyer, the seller, and the real estate agent.

### BACKGROUND OF THE INVENTION

The prospect of selling real estate is daunting for many individuals. For a typical seller, there are many questions that make the real estate selling experience difficult and undesirable. For example, the seller oftentimes has no idea how much or how little should be charged for real estate. Emotional ties to real estate tend to cloud the seller's judgment, and thus, the seller has an unrealistically high selling price for real estate. Also, the seller can be blinded by the inadequacies of real estate if the seller is actually living in the real estate. That is, the seller might be used to a cracked driveway, a damaged wall, or a landscaping disaster, so the seller believes that real estate is worth more than it actually is because the cracked driveway etc. does not bother the seller. In short, the seller is ill-equipped to sell real estate without the aid of a real estate professional.

Similarly, for a typical buyer, there are many questions that make the real estate selling experience difficult and undesirable. For example, the buyer oftentimes has no idea how much or how little should be paid for real estate. Superficial difficulties with real estate cloud the buyer's judgment—such as worn carpets or un-landscaped lots, and thus, the buyer has an unrealistically low concept of how much to actually pay for real estate. Also, the buyer can be blinded as to the true price of real estate once the buyer has fallen in love with real estate. That is, the buyer might so realistically envision the buyer owning the real estate that the buyer is oblivious to real price considerations. In short, the buyer is ill-equipped to buy real estate without the aid of a real estate professional.

Real estate professionals, or realtors, are a common part of the real estate selling and buying process because of the sellers' and buyers' needs, as stated above. The realtor is a so called “neutral party,” immune to the emotional and other ties that tend to affect the seller and the buyer. The realtor typically will represent either the buyer or the seller. In most real estate transactions, the seller chooses a first realtor and the buyer chooses a second realtor. The first realtor's job is to list the real estate to be sold. The second realtor's job is to locate a suitable piece of real estate for the buyer to purchase.

Unfortunately, in bad economic conditions, buyers and sellers frequently engage the services of realtors, but do not consummate a purchase and sale. In other words, a seller will hire the first realtor to list the real estate. Similarly, a buyer will hire the second realtor to locate real estate for purchase. However, the seller decides to delist real estate for sale and/or the buyer refrains from purchasing real estate. Normally, buyers and sellers hire realtors fully intending to buy and sell real estate. But when bad economic conditions exist, buyers might pull out of a potential sale because mortgages are too difficult to obtain. And when bad economic conditions exist, sellers might pull real estate off the market because the desired price for the real estate cannot be obtained.

For realtors, unconsummated sales mean that realtors work and do not get paid. A typical realtor that works for seller will list real estate, host open houses, network with other realtors, and even spend money for magazine and newspaper advertisements. A typical realtor that works for a buyer will identify a variety of real estate for purchase, take the buyer to different locations to view real estate, and even spend time touring with the buyer to identify the proper real estate for purchase. Without question, realtors are only paid when real estate sales are consummated. And thus, while realtors for buyers and sellers both want a sale to occur, realtors are always forced to expend time and energy with only an expectation of repayment. In some instances, realtors might be retained for the time spent, however such arrangements are rare. In summary, a real estate agent only gets paid when the buyer pays the seller.

While the scheme of realtor compensation has existed for years, it is an assumed risk that the realtor typically recognizes. In extended times of bad economic conditions, even though the realtor might know the compensation is conditioned on real estate sale, the realtor might have so many sales they go awry that the realtor cannot sustain a viable salary. Thus, there is a need for a method that provides a cushion for the realtor so that the realtor is not the victim of unconsummated real estate sales. When many properties are taken off the market and many buyers do not get mortgages, realtors do not get paid. Thus, there is a need for a method that encourages sellers to sell and buyers to buy. In addition, during bad economic conditions, sellers and buyers are looking to earn money or save money in any way possible. Thus, there is a need for a method that provides compensation for sellers and buyers as part of the real estate transaction—in other words, there is a need for payment and discounts beyond those typically found in a real estate transaction.

### SUMMARY OF THE INVENTION

The present invention is a method that provides an incentive to the buyer and the seller to consummate a real estate transaction. The buyer and the seller are hired as employees to perform a task. Once the task—the sale of real estate—has been accomplished, then the buyer and the seller are paid for acting in their capacities. This occurs in a scenario including the buying and selling sides of a company.

For a typical real estate transaction, according to the preferred embodiment of the present invention, there is a first realtor representing the seller, there is a second realtor representing the buyer, there is a first employee who is the seller, and there is a second employee who is the buyer. The first realtor is third employee, the second realtor is the fourth employee; and the first employee, the second employee, the third employee, and the fourth employee all have roles to play in the real estate transaction. All four employees must work together for the real estate transaction to occur. Once the real estate transaction occurs, and only if the real estate transaction occurs, are all four employees paid. A computer or similar device maintains employee records, controls employee compensation, and checks to see if a real estate sale has been consummated. The computer or similar device also maintains a company that essentially hires the first realtor, the second realtor, the seller, and the buyer to consummate a sale of real estate. The computer assigns the roles of the first realtor/ third employee, the second realtor/fourth employee, the first employee, and the second employee to allow the present invention to function.

### BRIEF DESCRIPTION OF THE DRAWINGS

FIG. 1 shows the typical relationship between a buyer, a seller, a first real estate agent, and a second real estate agent.

FIG. 2 shows the relationship between a buyer, a seller, a first real estate agent, and a second real estate agent, according to the present invention.

### DETAILED DESCRIPTION OF THE PREFERRED EMBODIMENT(S) OF THE PRESENT INVENTION

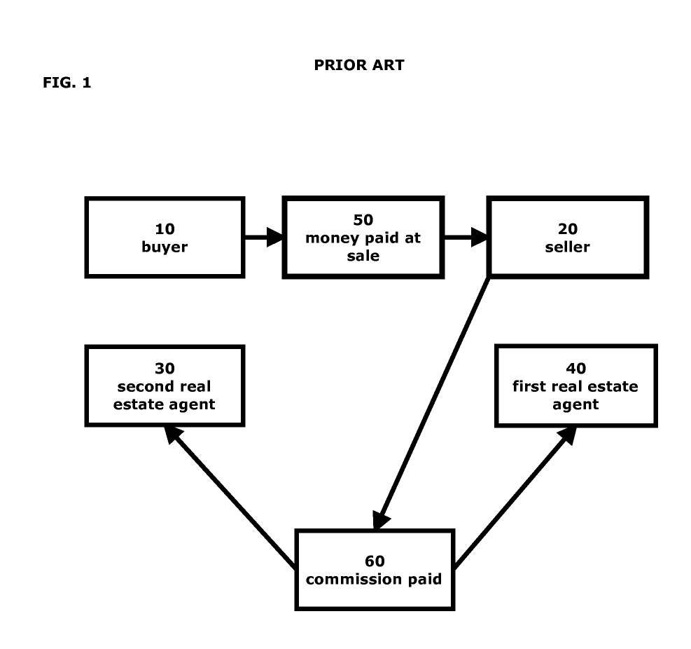

As shown in FIG. 1, a conventional real estate transaction occurs between a buyer 10 and a seller 20. Buyer 10 is looking to purchase real estate, and seller 20 is looking to sell real estate. Typically, buyer 10 needs help finding seller 20; and similarly, seller 20 requires assistance to find buyer 10. Buyer 10 most often hires second real estate agent 30 to find seller 20. Similarly, seller 20 most often hires first real estate agent 40 to find buyer 10. In other words, buyer 10 does not know which real estate is available at an appropriate price for purchase, and second real estate agent 30 has the means and knowledge to assist buyer 10. Buyer 10 most often is not familiar with the nuances of the real estate transaction, as well as negotiation techniques, but second real estate agent 30 can provide the needed assistance. In short, sell second real estate agent 30 or 20 does not know how to appropriately price real estate for sale, and seller 20 does not know which buyer to select to buy the real estate that seller 20 wants to sell. The seller 20 and buyer 10 receive 0.5% of sale price which can help a buyer have additional funds after purchase of house. Where at most times buyer 10 exhausts all to most funds in savings account, checking account, and/ or cash as gift to be able to close and purchase a house. First real estate agent 40 has the means and knowledge to assist seller 20. Additionally, seller 20 typically has little knowledge of the real estate transaction, as well as negotiation techniques, but first real estate agent 40 can provide the needed assistance. The agent 30 and agent 40 can assist buyer 10 and seller 20 to the sale through the company 110 to help both maximize the benefits of funds to employees at closing, which could assist in the removal of financial hurdles that buyer 10 may encounter in any sale of real estate to be financed. It is important to focus on the money trail that is shown in FIG. 1. Once second real estate agent 30 has helped the buyer 10, and first real estate agent 40 has helped seller 20, the sale of real estate is consummated with a signed contract for purchase of the real estate. Per the signed contract, buyer 10 transfers money paid at sale 50 to seller 20. Seller 20 then ensures that a commission is paid 60 to second real estate agent 30 and first real estate agent 40. In summary, only once there is a signed contract for purchase of the real estate is money paid at sale 50. And only once money is paid at sale 50 is commission paid 60 to second real estate agent 30 and first real estate agent 40. The unfortunate money trail, as shown in FIG. 1, is that unless money is paid at sale 50, there is not any commission paid 60 to second real estate agent 30 and first real estate agent 40.

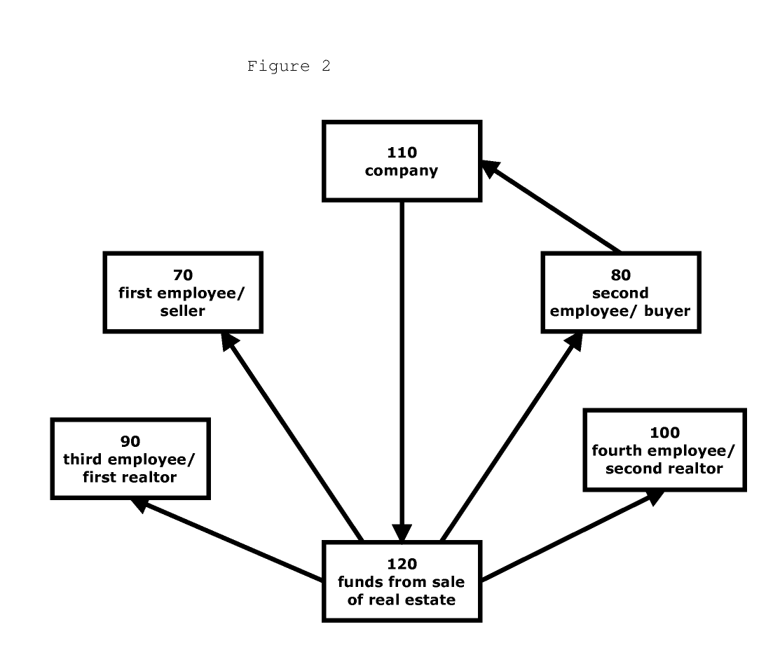

As shown in FIG. 2, which represents the present invention, a real estate transaction occurs between a buyer and a seller; however, in this real estate transaction, the seller is actually the first employee/seller 70, and the buyer is actually the second employee/buyer 80. The first employee/seller 70 still sells real estate, and the second employee/buyer 80 still buys real estate, just as a traditional seller and buyer normally act. The present invention employs first employee/seller 70 to sell real estate to second employee/buyer 80. The concept of employees is important to the present invention, because company 110 is the heart of the present invention, and is controlled by a computer or other device.

Company 110 is formed to manage real estate transactions amongst employees. For example, in the preferred embodiment of the present invention, company 110 hires many employees. Some of the employees hired are sellers, others are buyers, and still others are real estate agents. A computer or other computing device is used via conventional programming to keep track of and manage employees. Company 110 makes money from real estate transactions and employees first employee/seller 70, second employee/buyer 80, third employee/first realtor 90, and fourth employee/second realtor 100. It should be understood that first employee/seller 70, second employee/buyer 80, third employee/first realtor 90, and fourth employee/second realtor 100 are not necessarily four individuals who decide to join company 110 together to benefit from the present invention; but rather, first employee/seller 70, second employee/buyer 80, third employee/first realtor 90, and fourth employee/second realtor 100 are preferably individuals who have never met one another before. That is to say that first employee/seller 70, second employee/buyer 80, third employee/first realtor 90, and fourth employee/second realtor 100 are brought together as employees by the computer running company 110.

As one example of the present invention, first employee/seller 70, second employee/buyer 80, third employee/first realtor 90, and fourth employee/second realtor 100 each individually sign up as employees of company 110. First employee/seller 70 offers real estate for sale just as a typical seller would. If a typical buyer buys the real estate offered by first employee/seller 70, and the typical buyer is not an employee of company 110, then the present invention will still function. Seller will still receive agreed amount upon consummation of sale.

On the other hand, if a typical buyer purchases the real estate offered by first employee/seller 70, and the typical buyer is an employee of company 110, then the present invention will function fully. Similarly, if second employee/buyer 80 buys real estate for sale just as a typical seller would, and that real estate is sold by a typical seller that is not an employee of company 110, then the present invention will function, for that, the buyer that is an employee of the company 110 receives payment from the commission of the real estate agent and is distributed through company 110 to all employees involved. The commission from seller (20) is an agreed amount on traditional or company 110 sales and is given to traditional agent or company agent upon consummation of a sale. On the other hand, if second employee/buyer 80 buys real estate for sale just as a typical seller would, and that real estate is sold by a typical seller that is an employee of company 110, then the present invention will function fully. In short, the present invention does not restrict buyers and sellers from buying and selling real estate whatsoever; even if one or both sides are employees of company 110.

First employee/seller 70 and second employee/buyer 80 are free to choose any realtors that they desire or elect random agent from company 110. For the present invention to function, though, the realtors chosen by the first employee/seller 70 and the second employee/buyer 80 must be employees of the company 110. For example, should the realtor chosen by first employee/seller 70 be an employee of company 110, but the realtor chosen by second employee/buyer 80 is not an employee of company 110, then the present invention will not function. In the preferred embodiment of the present invention, first employee/seller 70 would look for a realtor that is employee of company 110. Second employee/buyer 80 would also look for a realtor that is an employee of company 110. Assuming that there are many employees of company 110, there would be a variety of sellers, buyers, and realtors to choose from. In addition, both employee/seller 70 and second employee/buyer 80 have signed, agreed, and understand of the process which yields money as incentive and motivation.

Following FIG. 2, second employee/buyer 80 transfers money to company 110 upon purchasing real estate from first employee/seller 70. The money received by company 110 is termed funds from sale of real estate 120. A computer or other device, upon receiving funds from sale of real estate 120, then pays first employee/seller 70, second employee/buyer 80, third employee/first realtor 90, and fourth employee/second realtor 100 rightful compensation as employees of company 110. Just like a traditional real estate transaction, the present invention has money being transferred from the buyer to the seller, and the present invention has second employee/buyer 80 transferring money to company 110 for distribution to employees.

According to the preferred embodiment of the present invention, each employee has a specific job or task, and each employee is paid upon completion of the specific job or task. First employee/seller 70 is charged with the job of selling real estate. Second employee/buyer 80 is charged with the job of buying real estate. Third employee/first realtor 90 is charged with the job of representing first employee/seller 70 to sell real estate. Fourth employee/second realtor 100 is charged with the job of representing second employee/buyer 80 to buy real estate.

The relationships between the employees of company 110 are handled by a computer or similar device. For example, a computer or similar device maintains records that third employee/first realtor 90 represents first employee/seller 70. Similarly, a computer or similar device maintains records that fourth employee/second realtor 100 represents second employee/buyer 80. A computer or similar device also tracks sales of real estate that occur between first employee/seller 70 and second employee/buyer 80. And as mentioned above, a computer or similar device collects and pays funds from sale of real estate 120 to first employee/seller 70, second employee/buyer 80, third employee/first realtor 90, and fourth employee/second realtor 100.

Alternate embodiments of the present invention may include employing the present invention within other commission-based sales transactions or constructs, such as the sale of vehicles including house boats, recreational vehicles (RVs), or other transports.

Another alternate embodiment of the present invention includes implementation into a ‘home equity savings plan.’ This process is similarly designed to help all parties involved in a real estate transaction. A home equity savings plan is geared toward assisting the buyer. It includes the first employee/buyer 80, second employee/seller 70, third employee/first realtor 90, and fourth employee/second realtor 100. The process is outlined as follows:

In the past, home builders used seller-funded programs to artificially inflate home prices by as much as 6 percent before passing that money to buyers. In April 2011 the Federal Reserve introduced their new “compensation” rule. The final rule amends the Truth in Lending Act (TILA) and Regulation Z. Based on current Regulation Z and YSP and amendments to TILA the borrower can pay the compensation, or the lender can, but not both. No originator may receive compensation, directly or indirectly, from any person other than the consumer in connection with transaction. YSP is overage credited to consumer on transaction funded by creditor. Consumer monies include both money they have in their possession (60 days or more) before they walk into a closing, as well as the cash-back from the Home Equity. Seller-paid closing costs are also considered consumer funds. By way of use of this process the Company” 110 is the Creditor, this then does show the money for down payment is coming from “the Company” 110 (Creditor's) private funds, which are paid to the buyer upon agreeing to consummate the sale, but prior to the actual act of consummation. Creditor is the Institution(s) that fund loans with their own capital or a bona-fide warehouse line of credit. Funds are paid via a paycheck to all employee parties. There is preferably no price increase by the seller to absorb down payment. The Home Equity is supplying the amount for down payment to Buyer (consumer). Again, consumer's money is both funds he or she has in their possession prior to closing, as well as cash-back from the equity in the home.

By the Creditor using the home equity in this fashion, the consumer is able to use the funds as down payment for the purchase of the real estate. This is not a government grant, the Tax payers are not paying for this process, and the money is coming from the Home Equity of the house via the Creditor giving the loan to buyer through the company 110. In addition, during bad economic conditions, sellers and buyers are looking to earn money or save money in any way possible. Thus, there is a need for a method that provides compensation for sellers and buyers as part of the real estate transaction—in other words, there is a need for payment and discounts beyond those typically found in a real estate transaction. This process is controlled and monitored for same and safe results of each and every transaction by way of computer.

First, the credit of the buyer must be determined. After finding good credit, it is then determined if the buyer needs down payment assistance, and/or additional savings of buyer funds to close on the sale. Down payment assistance via an alternate method of the present invention involves paying funds via a paycheck to first employee/buyer 70 from the company 110 prior to the actual consummation of the sale in exchange for the first employee/buyer's 70 commitment to consummate the sale at a later time. Funds are paid from the company 110 to the first employee/buyer 70 preferably via a check based on the terms that the buyer must then officially consummate the sale by an established date. It should be understood that, in this embodiment of the present invention that the computer would pay funds from the company 110 prior to the real estate sale. In other words, the computer would pay out funds to the employees prior to receiving any money from the real estate sale. In one embodiment, all employees (a first employee/seller 70, a second employee/buyer 80, a third employee/first realtor 90 and a fourth employee/second realtor 100) are paid upon, completion of the consummated sale. Thus, funds are paid simultaneously by the company 110 to all employees involved in the sale of a specific property. However, in the preferred embodiment of the present invention, only the buyer is paid funds by the company 110 upon the agreement to consummate the real estate sale. The buyer is paid funds by the company 110 prior to the act of consummation so that the buyer may use the funds towards the down payment on the property at closing. This is effectively a form of a special grant of monies from a designated account owned by the company 110, to the buyer, separate from other employees and accounts involved in the real estate transaction Again, these funds may then be used as the down payment for the real estate pending consummation. Upon consummation of the sale, the company 110 is reimbursed for funds paid to the first employee/buyer 70 via the commission generated from the sale, which is divided among the remaining employees in accordance with pre-established percentage values. This will increase real estate sales and slowly rebuild the median sale price in every neighborhood. The present invention may be utilized toward the sale of new homes, as well as bank owned properties. In all real estate transactions, agents have an obligation to keep their client's best interest in mind. When buyers are missing a particular piece, it usually pertains to funding and not the buyer's FICA score. Therefore, preferably all parties benefit from the commission of sale from net. This process will assist everyone that is not eligible for a VA loan and can even help VA buyers as well with additional savings.

It should be understood that the second employee/buyer 80 could preferably receive 0.5% of a sale price of the real estate transaction—and this 0.5% of the sale price of the real estate transaction can help second employee/buyer 80 have additional funds after purchase of the real estate, as at most times second employee/buyer 80 exhausts all to most funds in any savings 10 account, checking account, and/ or cash as gift to be able to purchase the real estate. Similarly, first employee/seller 70 could preferably receive 0.5% of a sale price of the real estate transaction. It should be understood that the percentage received by second employee/buyer 80 and first employee/seller 70 could vary.

It should also be understood that there are often financial hurdles faced by the second employee/buyer 80, and in order to help purchase the real estate, first employee/seller 70 could choose to share all or part of money received from real estate 120 with second employee/buyer 80. This would be preferably handled via the company 110 such that the amount of money paid by the company 110 to the first employee/seller 70 would be reduced by extra money paid to the second employee/buyer 80.

Upon a ratified, standard purchase contract, all parties sign the agreement with the company 110 as individual employees. This agreement is preferably preset, and is formulated to take all commissions from the eventual sale of a property, and then pay all parties involved with the real estate sale. On the HUD-1, it will show that Agent Commissions are to be sent to the company 110. Simultaneously, at closing all parties (first employee/seller 70, second employee/buyer 80, third employee/first realtor 90, and fourth employee/second realtor) receive a pay check for services. Simultaneously, as the second employee/buyer 80 signs the purchase of property transaction contract, HUD-1, and closing documents will receive 3.5% as a pay check which will be handed to the closing company as Buyer's Down Payment of 3.5%. This could be in a form of certified funds or wired from the company account with buyer's name which was established at time of signing the company agreement and employee form. The agent commissions will be paid to their brokerage from the company 110 for services. The first employee/Seller 70, as an employee of the company 110, will receive a pay check for services from same preset formula found in the company agreement.

In summation, the first embodiment of the present invention involves the creation of a company 110. The company 110 hires employees, including a first employee/seller 70, a second employee/buyer 80, a third employee/first realtor 90 and a fourth employee/second realtor 100. The third employee/first realtor 90 is selected from a group of realtors by the first employee/seller 70. The fourth employee/second realtor 100 is selected by the second employee/buyer 80. In this first embodiment, as stated above, only the second employee/buyer 70 is paid prior to actual sale. This is based on the notion that the second employee/buyer 70 lacks the required down payment funds independently, therefore the funds paid from the company to the second employee/buyer 70 go towards the sale. The source of the funds to be given to the second employee/buyer 70 is from within a private account held by the company itself, which is, in effect, later reimbursed after the consummation of the real estate sale, via the commissions from the real estate sale.

In the second embodiment of the present invention, all employees related to the sale of real estate are paid simultaneously after actual act of consummation. This is likely to be performed in the event that the second employee/buyer 70 has independent, personal funds that meet or exceed the down payment for the real estate. In this embodiment, the second employee/buyer 70 may use the funds towards new home furnishings or other expenses.

In the third embodiment of the present invention, the second employee/buyer 70 is assigned funds by the company 110 before the second employee/buyer 70 finds real estate he or she desires to purchase. The funds are set aside within the bank account of the company 110, where they are reserved for the second employee/buyer upon the discovery of desired real estate. The value of the funds set aside is preferably estimated based off of the desired purchase price of the real estate. Given that the desired real estate has not yet been located by the second employee/buyer 70 in this embodiment, the value of the needed funds is estimated until the second employee/buyer 70 finds a specific piece of real estate, and arrives at an asking price. These company 110 funds are assigned to the second employee/buyer 70 in the second employee/buyer's 70 own name in an independent company account as they become a employee of the company 110, and begin searching for real estate to purchase. If real estate has been already found by an individual, then he or she then becomes a second employee/buyer 80, and the second employee/buyer's name is entered into a separate account to temporarily hold the second employee/buyer's 80 funds until actual consummation of the sale of real estate. The funds are calculated to be 3.5% of the cost of the real estate, in order to equal the down payment dollar amount.

The account at the bank is in the name of the company 110, and each second employee/buyer 70 receives his/her own account to hold the exact amount necessary to use for the down payment for the real estate sale. At the same time that second employee/buyer 80 gets paid by the company, the first employee/seller 70 with home equity gets the house sold by providing funds to the buyer via the inherent home equity of the property, and then is paid by net and receives a company pay check as an employee. Additionally, given that the third employee/first realtor 90 and the fourth employee/second realtor 100 ensured that the sale was performed smoothly and produced work in order to complete the sale, they are paid by the company 110 as well. It is envisioned that the company 110 also takes a small percentage of the overall commission from the real estate sale. It is to be understood that, in all embodiments of the present invention, the source of funds paid to all employees is from a separate account held privately by the company 110.

I claim:

1. A method for a real estate sale using a computer comprising:
the computer creating a first file that identifies a seller as a first employee;
the computer creating a second file that identifies a buyer as a second employee;
the computer creating a third file that designates a first realtor as a third employee;
the computer creating a fourth file that designates a second realtor as a fourth employee, and;
the computer creating a fifth file for a company, wherein the first file, the second file, the third file, and the fourth file are associated as employees of the company.

2. The method of claim 1, wherein the computer keeps a database of realtors to become the second employee.

3. The method of claim 1, wherein the first employee chooses the third employee.

4. The method of claim 1, wherein the first employee chooses the fourth employee.

5. The method of claim 2, wherein the first employee chooses a third employee.

6. The method of claim 2, wherein the first employee chooses the fourth employee.

7. The method of claim 2, further comprising:
the computer establishing a record of funds from the real estate sale;
the computer initiating a transaction to pay funds from the real estate sale;
the computer paying funds from the real estate sale to the first employee buyer; and
the computer allocating funds to the second employee seller, third employee first realtor, and fourth employee second realtor.

8. The method of claim 3, wherein the computer keeps a database of realtors to become the second employee.

9. The method of claim 3, wherein the first employee buyer chooses a fourth employee.

10. The method of claim 3, further comprising:
the computer establishing a record of funds from the real estate sale;
the computer initiating a transaction to pay funds from the real estate sale;
the computer paying funds from the real estate sale from the first employee buyer; and
the computer allocating funds to first employee buyer, second employee buyer, third employee first realtor, and fourth employee second realtor in accordance with established compensation agreements.

11. The method of claim 4, wherein the computer keeps a database of realtors to become the second employee.

12. The method of claim 4, wherein the first employee seller chooses a third employee.

13. The method of claim 4, further comprising:
the computer establishing a record of funds from the real estate sale;
the computer initiating a transaction to pay funds from the real estate sale;
the computer paying funds from the real estate sale from the first employee buyer; and
the computer allocating funds to first employee buyer, second employee buyer, third employee first realtor, and fourth employee second realtor in accordance with established compensation agreements.

14. The method of claim 1, further comprising:
the computer establishing a record of funds from the real estate sale;
the computer initiating a transaction to pay funds from the real estate sale;
the computer paying funds from the real estate sale from the first employee buyer; and
the computer allocating funds to first employee buyer, second employee buyer, third employee first realtor, and fourth employee second realtor in accordance with established compensation agreements.

15. A method for a real estate sale using a computer comprising:
the computer creating a first file that identifies a seller as a first employee;
the computer creating a second file that identifies a buyer as a second employee;
the computer creating a third file that designates a first realtor as a third employee;
the computer creating a fourth file that designates a second realtor as a fourth employee;
the computer creating a fifth file for a company, wherein the first file, the second file, the third file, and the fourth file are associated as employees of the company; and
the computer initiating a transaction to pay funds from the company to the second employee prior to the real estate sale.

16. The method of claim 15, wherein the computer keeps a database of realtors to become the second employee.

17. The method of claim 15, wherein the first employee seller chooses a third employee.

18. The method of claim 15, wherein the first employee buyer chooses a fourth employee.

19. A method for real estate sale using a computer comprising:
the computer creating a first file that identifies a seller as a first employee;
the computer creating a second file that identifies a buyer as a second employee;
the computer creating a third file that designates a first realtor as a third employee;
the computer creating a fourth file that designates a second realtor as a fourth employee;
the computer creating a fifth file for a company, wherein the first file, the second file, the third file, and the fourth file are associated as employees of the company;
the computer establishing a record of funds from the real estate sale;
the computer initiating a transaction to pay funds from the real estate sale;
the computer paying funds from the real estate sale from the first employee buyer before the act of consummating the real estate sale; and
the computer allocating funds to first employee buyer, second employee buyer, third employee first realtor, and fourth employee second realtor according to an agreed rate.
